(19) United States
(12) Patent Application Publication
(10) Pub. No.: US 2015/0145449 A1
(43) Pub. Date: May 28, 2015

(54) ROTATING ELECTRIC MACHINE DRIVER AND ELECTRIC POWER STEERING DEVICE

(71) Applicant: DENSO CORPORATION, Kariya-city (JP)

(72) Inventors: Yasuhiko MUKAI, Chita-city (JP); Hideki KABUNE, Nagoya-city (JP)

(21) Appl. No.: 14/553,385

(22) Filed: Nov. 25, 2014

(30) Foreign Application Priority Data
Nov. 26, 2013 (JP) 2013-243836

(51) Int. Cl. H02P 6/12; B62D 5/04

(52) U.S. Cl. CPC H02P 6/12; B62D 5/046; B62D 5/0487
USPC 318/400.22

(57) ABSTRACT

A rotating electric machine driving apparatus includes a controller section that obtains an electric current detection value and generates instruction signals for switching ON and OFF of switching elements based on the electric current detection value. The rotating electric machine driving apparatus also includes an IC that is provided with a signal amplifier for outputting amplified signals, which are amplified instruction signals output from the controller section. When an abnormal state, in which one of an instruction signal and an amplified signal amplifying the instruction signal is an ON instruction and the other one of the instruction signal and the amplified signal is an OFF instruction, continues for at least an abnormality determination time, an abnormality detector determines an abnormality of the amplified signal, which realizes an appropriate detection of an abnormality of the amplified signal.

### CROSS REFERENCE TO RELATED APPLICATION

The present application is based on and claims the benefit of priority of Japanese Patent Application No. 2013-243836, filed on Nov. 26, 2013, the disclosure of which is incorporated herein by reference.

### TECHNICAL FIELD

The present disclosure generally relates to a rotating electric machine driver and an electric power steering device using such driver.

### BACKGROUND INFORMATION

Conventionally, in a rotating electric machine driver, the electric current in each of three phases is detected based on a detected electric current value of a shunt resistor that is disposed on a bus line of an inverter. For example, in a patent document 1 (i.e., Japanese Patent Publication: JP-A-2013-110864), two systems of circuits which respectively amplify the voltage between both ends of the shunt resistor are provided.

In the patent document 1, it is disclosed that faults and abnormalities of the current detector circuit are detected and/or diagnosed by having two systems of circuits for amplifying the voltage between both ends of the shunt resistor.

However, the technique in the patent document 1 cannot detect the abnormalities (henceforth may also be designated as an “open failure”) and other faults which disable a connection of the switching element in the inverter, that is, a disabling of a switch ON of the switching element). The open failure disabling the conduction of the switching element may not only arise from an abnormality of the switching element itself but may also arise from an abnormality of an instruction signal that switches ON the switching element or from an abnormality of an amplified signal that is derived by amplifying the instruction signal.

### SUMMARY

It is an object of the present disclosure to provide a rotating electric machine driver that is capable of detecting an amplified signal abnormality, i.e., abnormalities of an amplified signal that is derived by amplifying an instruction signal, and to provide an electric power steering device using such driver.

In an aspect of the present disclosure, a rotating electric machine driver of the present disclosure is provided with an inverter section, an electric current detector, a controller section, a driver circuit, and an abnormality detector.

The inverter section has a plurality of switching elements corresponding to each of plural phases of a winding wire of a rotating electric machine.

The electric current detector detects an electric current supplied to the winding wire.

The controller section obtains a current detection value detected by the electric current detector and generates an instruction signal that switches an ON-OFF of the switching elements based on the current detection value.

The driver circuit has a signal amplifier that outputs an amplified signal to the inverter section. The amplified signal is derived from amplification of the instruction signal that is output from the controller section.

The abnormality detector determines abnormalities of the amplified signal when a one-on one-off state continues for at least an abnormality determination time, the one-on one-off state being a state in which one of the instruction signal and the amplified signal is an ON instruction and an other of the instruction signal and the amplified signal is an OFF instruction.

In such manner, abnormalities of the amplified signal which is the amplified instruction signal are appropriately detectable.

Further, for example, when the electric current detector is disposed at a position between the inverter section and a negative side of a power supply for detecting a bus line current, at a time of open failure arising from abnormalities of the amplified signal, the phase and the power supply direction of the bus line current detected by the current detector may be falsely detected or mis-detected.

Therefore, in the present disclosure, the abnormality detector detects abnormalities of the amplified signal. Thus, by preventing a mis-detection of the electric current in each of the plural phases, an unintended behavior of the rotating electric machine is prevented.

Also, in the present disclosure, a response delay time is defined as a time period between an output of the instruction signal from the controller section and an output of the amplified signal from the signal amplifier. A minimum retention time is defined as a time period between a start timing of a voltage vector period during which an electric current is detected by the electric current detector and a detection timing for detecting the electric current. As such, the abnormality determination time is longer than the response delay time and equal to or shorter than the minimum retention time.

Further, the rotating electric machine driver of the present disclosure includes a protection section in the driver circuit that stops a generation of the amplified signal. The instruction signal is a high-side instruction signal or a low-side instruction signal, the high-side instruction signal switching ON and OFF of an upper arm element disposed on a high potential side, and the low side instruction signal switching ON and OFF of a lower arm element disposed on a low voltage side with regard to the upper arm element on the high potential side. The protection section stops the generation of the amplified signal when both of the high-side instruction signal and the low-side instruction signal indicate switching ON of a pair of the upper arm element and the lower arm element.

Moreover, in the present disclosure, the abnormality detector is disposed in the driver circuit.

Even further, in the present disclosure, the electric current detector is disposed at a position between the inverter section and a positive side or a negative side of a power supply.

Additionally, in the present disclosure, the controller section includes a monitor section that determines whether an abnormality detection by the abnormality detector is functioning normally.

Yet further, in the present disclosure, an electric power steering apparatus is provided with a rotating electric machine driver having an inverter section, an electric current detector, a controller section, a driver circuit, and an abnormality detector.

The inverter section has a plurality of switching elements respectively corresponding to each of plural phases of a winding wire of a rotating electric machine.

The electric current detector detects an electric current supplied to the winding wire.

The controller section obtains a current detection value detected by the electric current detector and generates an instruction signal that switches an ON-OFF of the switching elements based on the current detection value.

The driver circuit has a signal amplifier that outputs an amplified signal to the inverter section. The amplified signal is derived from amplification of the instruction signal that is output from the controller section.

The abnormality detector determines abnormalities of the amplified signal when a one-on one-off state continues for at least an abnormality determination time, the one-on one-off state being a state in which one of the instruction signal and the amplified signal is an ON instruction and an other of the instruction signal and the amplified signal is an OFF instruction.

### BRIEF DESCRIPTION OF THE DRAWINGS

Objects, features, and advantages of the present disclosure will become more apparent from the following detailed description made with reference to the accompanying drawings, in which:

FIG. 1 is a configuration diagram of an electric power steering system in one embodiment of the present disclosure;

FIG. 2 is a configuration diagram of a rotating electric machine driver in one embodiment of the present disclosure;

FIG. 3 is a diagram of a relationship between a switching element on-off state and a bus line current in one embodiment of the present disclosure;

FIG. 4 is a time diagram of a relationship between an instruction signal and the bus line current in one embodiment of the present disclosure;

FIG. 5 is a schematic diagram of the rotating electric machine driver and a flow of an electric current flowing therein at a switching element normal operation time in one embodiment of the present disclosure;

FIG. 6 is a schematic diagram of the rotating electric machine driver and a flow of an electric current flowing therein at a switching element open failure time in one embodiment of the present disclosure;

FIG. 7 is a schematic diagram of the rotating electric machine driver and a flow of an electric current flowing therein at the switching element normal operation time when a shunt resister is disposed in each of multiple phases in one embodiment of the present disclosure;

FIG. 8 is a schematic diagram of the rotating electric machine driver and a flow of an electric current flowing therein at the switching element open failure time when the shunt resister is disposed in each of multiple phases in one embodiment of the present disclosure;

FIG. 9 is a time diagram of an abnormality signal at an amplified signal normal time in one embodiment of the present disclosure;

FIG. 10 is a time diagram of the abnormality signal at an amplified signal abnormal time in one embodiment of the present disclosure;

FIG. 11 is a flowchart of an initial check process in one embodiment of the present disclosure;

FIG. 12 is a continuation of a flowchart of the initial check process in one embodiment of the present disclosure;

FIG. 13 is another continuation of a flowchart of the initial check process in one embodiment of the present disclosure; and

FIG. 14 is a flowchart of an abnormality determination process in one embodiment of the present disclosure.

### DETAILED DESCRIPTION

Hereafter, a rotating electric machine driver by the present disclosure and the electric power steering device using such driver are described based on the drawing.

### One Embodiment

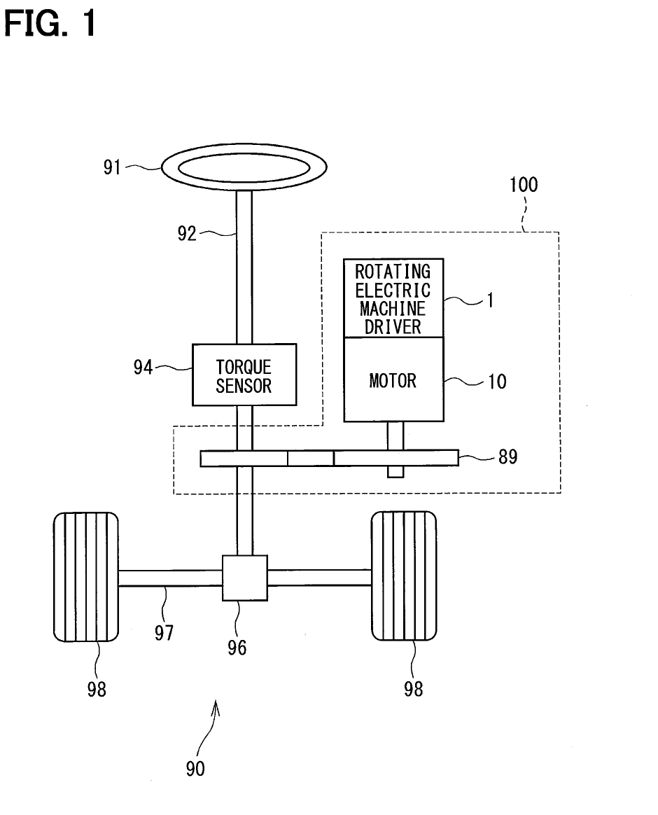

The rotating electric machine driver in one embodiment of the present disclosure and the electric power steering device using such driver are shown in FIGS. 1-14.

FIG. 1 shows an entire configuration of a steering system 90 provided with an electric power steering device 100. The steering system 90 comprises a steering wheel 91, a steering shaft 92, a pinion gear 96, a rack shaft 97, a wheel 98, the electric power steering device 100 and the like.

The steering wheel 91 is connected with the steering shaft 92. The steering shaft 92 has a torque sensor 94 which detects a steering torque inputted to the steering shaft 92 when a driver operates the steering wheel 91. On a tip end of the steering shaft 92, the pinion gear 96 is disposed, and the pinion gear 96 engages the rack shaft 97. To both ends of the rack shaft 97, a pair of wheels 98 are connected via a tie rod or the like.

Thereby, when the driver rotates the steering wheel 91, the steering shaft 92 connected with the steering wheel 91 rotates. A rotational movement of the steering shaft 92 is converted into a translational motion of the rack shaft 97 by the pinion gear 96, and the pair of wheels 98 are steered by an angle according to the displacement amount of the rack shaft 97.

The electric power steering device 100 has a speed reduction gear 89 for reducing a speed of rotation of the motor 10 and outputting the rotation to the steering shaft 92 or to the rack shaft 97, as well as the motor 10 which outputs an assist torque for assisting a steering operation of the steering wheel 91 by the driver, the rotating electric machine driver 1 which is used for a drive control of the motor 10, and the like.

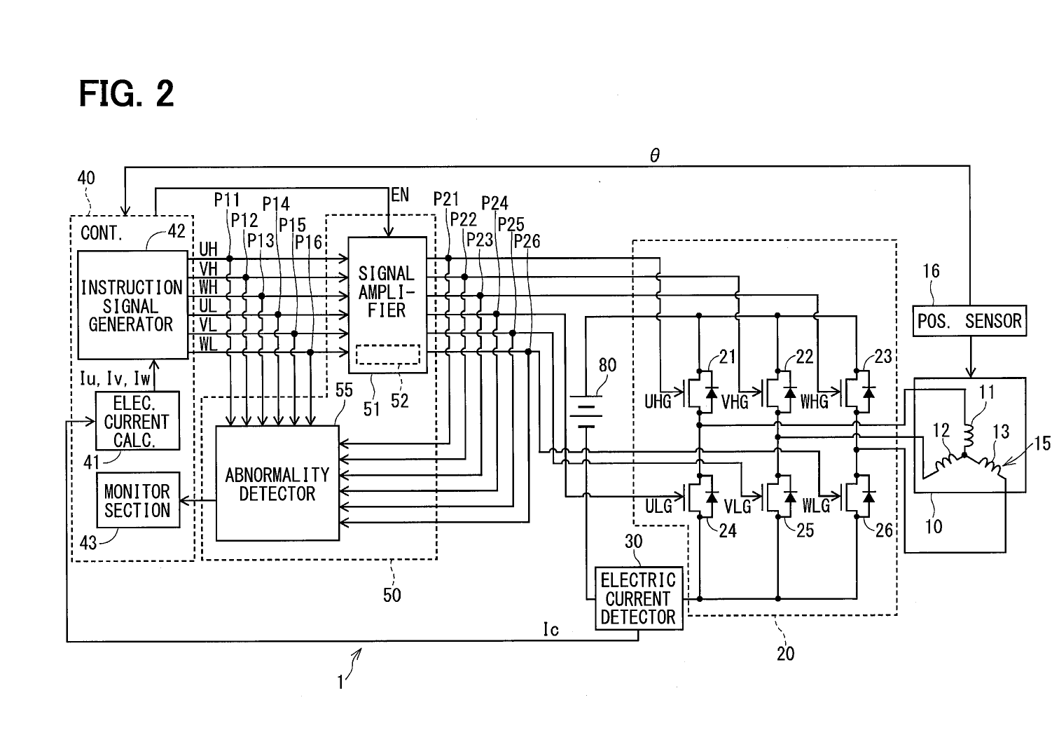

The motor 10 is driven by a supply of an electric power from a battery 80 (refer to FIG. 2), and rotates the speed reduction gear 89 in a forward and backward direction.

The motor 10 is a three-phase brushless motor, and has a rotor and a stator which are not illustrated. The rotor is a cylindrical component, and a permanent magnet is attached on its surface for establishing a magnetic pole. The stator accommodates the rotor in its radial inside in a rotatable manner.

The stator has a projection part which projects at each specified angle toward the radial inside, on which a winding wire of each of a U phase coil 11, a V phase coil 12, and a W phase coil 13 is wound as shown in FIG. 2. The U phase coil 11, the V phase coil 12, and the W phase coil 13 constitute a winding wire 15. In the present embodiment, an electric current in the U phase coil 11 is a U phase current Iu, an electric current in the V phase coil 12 is a V phase current Iv, and an electric current in the W phase coil 13 is a W phase current Iw. The U phase current Iu, the V phase current Iv, and the W phase current Iw may also be designated as “phase currents Iu, Iv, Iw.” Further, the motor 10 has a position sensor 16 which detects an electrical angle θ which represents a rotation position of the rotor.

As shown in FIG. 2, the rotating electric machine driver 1 performs a drive control of the motor 10 by pulse width modulation (i.e., “PWM”), and is provided with an inverter 20, a current detector 30, a controller 40, a custom IC 50 as a driver circuit, the battery 80 as a power supply and the like.

The inverter 20 is a three-phase inverter, and a bridge connection of the six switching elements 21-26 is provided to switch the electric current of the U phase coil 11, the V phase coil 12, and the W phase coil 13 flowing therethrough, respectively. Although the switching elements 21-26 of the present embodiment are MOSFET (i.e., metal-oxide-semiconductor field-effect transistor) which is a kind of a field effect transistor, other transistors may also be used. Hereafter, the switching elements 21-26 may also be designated as “SW 21-26.”

As for three SW 21-23, a drain of each of them is connected to a positive terminal of the battery 80. Further, a sauce of each of the SW 21-23 is connected to the drain of each of the SW 24-26, respectively. A sauce of each of the SW 24-26 is connected to a negative terminal of the battery 80 via the current detector 30.

A junction point of the SW 21 and the SW 24 which are paired is connected to one end of the U phase coil 11. A junction point of the SW 22 and the SW 25 which are paired is connected to one end of the V phase coil 12. A junction point of the SW 23 and the SW 26 which are paired is connected to one end of the W phase coil 13.

According to the present embodiment, in terms of wordings in the claims, the SW 21-23 connected to a high potential side respectively correspond to an “upper arm element”, and the SW 24-26 connected to the low potential side respectively correspond to a “lower arm element.”

In the following, the SW 21-23 on the high potential side may be respectively designated as the “upper arm element,” and the SW 24-26 on the low potential side may be respectively designated as the “lower arm element.” The current detector 30 is disposed at a position between the low potential side of the inverter 20 and the negative terminal of the battery 80, and detects a bus line current of the inverter 20. The current detector 30 of the present embodiment is a shunt resistor. Hereafter, the current detector 30 may be designated as the “shunt resistor 30.” According to the present embodiment, both ends voltage of the shunt resistor 30 is outputted to the controller 40 as a detected current value Ic, after an amplification process and a noise reduction process.

The controller 40 controls an entire rotating electric machine driver 1 as a whole, and is constituted by a microcomputer etc. which performs various operations. The controller 40 determines the assist torque based on the steering torque detected by the torque sensor 94, vehicle speed information from a speed sensor which is not illustrated, etc., and controls the drive of the motor 10 so that the determined assist torque is outputted from the motor 10.

The controller 40 has an electric current calculator 41, an instruction signal generator 42, a monitor section 43 and the like.

The electric current calculator 41 obtains the detected current value Ic which has undergone the amplification process and the noise reduction process, and calculates each of the phase currents Iu, Iv, Iw based on the detected current value Ic. The calculation of each of the phase currents Iu, Iv, Iw is mentioned later.

The instruction signal generator 42 generates instruction signals UH, UL, VH, VL, WH, WL which respectively control switching on-off of the SW 21-26, based on each of the phase currents Iu, Iv, Iw, calculated by the electric current calculator 41 and the electrical angle θ obtained from the position sensor 16, together with other factors.

More practically, the instruction signal generator 42 calculates, by a PI calculation, a d axis voltage instruction value Vd* and a q axis voltage instruction value Vq* so that a deviation between (i) a d axis current instruction value Id* and a q axis current instruction value Iq* that are determined based on a torque instruction value and (ii) a d axis detected current value Id* and a q axis detected current value Iq* based on a dq conversion of each of the phase currents Iu, Iv, Iw that are derived from the detected current value Ic becomes zero. Further, each of the phase voltage instruction values Vu*, Vv*, Vw* is calculated by an inverted dq conversion of the d axis voltage instruction value Vd* and the q axis voltage instruction value Vq*, and each of the phase voltage instruction values Vu*, Vv*, Vw* is converted to each of duty instruction values Du, Dv, Dw.

Then, the instruction signal generator 42 generates the instruction signals UH, UL, VH, VL, WH, WL by comparing the duty instruction values Du, Dv, Dw with a carrier signal C. The generated instruction signals UH, UL, VH, VL, WH, WL are outputted to the custom IC 50.

Since the instruction signal UH is a signal concerning switching on-off of the SW 21, the SW 21 is switched on when the signal UH is an ON instruction, and the SW 21 is switched off when the signal UH is an OFF instruction. Similarly, since the instruction signal VH is a signal concerning switching on-off of the SW 22, and the instruction signal WH is a signal concerning switching on-off of the SW 23. Further, the instruction signal UL is a signal concerning switching on-off of the SW 24, the instruction signal VL is a signal concerning switching on-off of the SW 25, and the instruction signal WL is a signal concerning switching on-off of the SW 26.

According to the present embodiment, in terms of wordings in the claims, the instruction signals UH, VH, WH respectively correspond to a “high-side instruction signal” and instruction signals UL, VL, WL respectively correspond to a “low-side instruction signal” in the claims.

The monitor section 43 monitors abnormalities of an abnormality detector 55.

The custom IC 50 includes a signal amplifier 51 and the abnormality detector 55.

The signal amplifier 51 amplifies the instruction signals UH, UL, VH, VL, WH, WL that are output from the controller 40, and generates amplified signals UHG, ULG, VHG, VLG, WHG, WLG respectively having a raised drive voltage that is capable of driving each of the SW 21-26. The generated amplified signals UHG, ULG, VHG, VLG, WHG, WLG are outputted respectively to each of the SW 21-26.

In the signal amplifier 51, when an amplification permission signal EN transmitted from the controller 40 is ON, the amplified signals UHG, ULG, VHG, VLG, WHG, WLG are generated, and the signals UHG, ULG, VHG, VLG, WHG, WLG are output to the SW 21-26. When the amplification permission signal EN is OFF, generation of the amplified signals UHG, ULG, VHG, VLG, WHG, WLG is stopped.

The amplified signal UHG is a signal concerning switching on-off of the SW 21, and the SW 21 is switched on when the signal UHG is an ON instruction, and the SW 21 is switched off when the signal UHG is an OFF instruction. Similarly, the amplified signal VHG is a signal concerning switching on-off of the SW 22, and the amplified signal WHG is a signal concerning switching on-off of the SW 23, and the amplified signal ULG is a signal concerning switching on-off of the SW 24, and the amplified signal VLG is a signal concerning switching on-off of the SW 25, and the amplified signal WLG is a signal concerning switching on-off of the SW 26.

Further, when both of the instruction signals UH and UL are an ON instruction, in case that the amplified signals UHG, ULG that are derived by amplifying the instruction signals UH and UL are output to the inverter 20, a pair of SW 21 and SW 24 are simultaneously switched ON, and an excessive current may be supplied thereto. The same may apply to the V phase and the W phase.

Therefore, the signal amplifier 51 has a self-protecting circuit 52. The self-protecting circuit 52 comprises a U phase protection circuit, a V phase protection circuit and a W phase protection circuit. The U phase protection circuit stops generation of the amplified signals UHG, ULG, when both of the instruction signals UH and UL are an ON instruction. The V phase protection circuit stops generation of the amplified signals VHG and VLG, when both of the instruction signals VH and VL are an ON instruction. The W phase protection circuit stops generation of the amplified signal WHG, WLG, when both of the instruction signals WH and WL are an ON instruction. According to the present embodiment, the self-protecting circuit 52 corresponds to a “protection section” in the claims.

The abnormality detector 55 obtains the instruction signals UH, UL, VH, VL, WH, WL outputted from the controller 40 via terminals P11-P16. Further, the abnormality detector 55 obtains of the amplified signals UHG, ULG, VHG, VLG, WHG, WLG outputted from the signal amplifier 51 via terminals P21-P26. Then, based on the obtained signals, i.e., the instruction signals UH, UL, VH, VL, WH, WL and the amplified signals UHG, ULG, VHG, VLG, WHG, WLG, the abnormality detector 55 monitors abnormalities of the amplified signals UHG, ULG, VHG, VLG, WHG, WLG.

More practically, the abnormality detector 55 detects abnormalities in a path from the terminals P11-P16 to the terminals P21-P26. More specifically, the abnormality detector 55 monitors a break/disconnection and a short circuit to a high-/low-side of a path from the terminals P11-P16 to the signal amplifier 51 and of a path from the signal amplifier 51 to the terminals P21-P26 as well as monitoring an internal abnormality of the signal amplifier 51.

The abnormality detector 55 includes a U phase detector which detects the abnormalities of the U phase, a V phase detector which detects the abnormalities of the V phase, and a W phase detector which detects the abnormalities of the W phase.

The U phase detector detects the abnormalities of the amplified signals UHG, ULG concerning the U phase. When the amplified signal UH is abnormal, a U phase upper abnormality flag FlgUH is set. When the amplified signal UL is abnormal, a U phase lower abnormality flag FlgUL is set.

The V phase detector detects the abnormalities of the amplified signals VHG, VLG concerning the V phase. When the amplified signal VH is abnormal, a V phase upper abnormality flag FlgVH is set. When the amplified signal VL is abnormal, a U phase lower abnormality flag FlgVL is set.

The W phase detector detects the abnormalities of the amplified signals WHG, WLG concerning the W phase. When the amplified signal WH is abnormal, a W phase upper abnormality flag FlgWH is set. When the amplified signal VL is abnormal, a U phase lower abnormality flag FlgWL is set.

The information about the abnormality flags FlgUH, FlgUL, FlgVH, FlgVL, FlgWH, FlgWL is transmitted to the controller 40 by a serial communication, in response to a transmission request from the controller 40.

The U phase detector includes a comparison circuit that compares the instruction signal UH with the amplified signal UHG, a comparison circuit that compares the instruction signal UL with the amplified signal ULG, a counter circuit, a flag circuit and the like. These circuits may be implemented as hardware, or may be implemented as software, or may also be implemented as a combination of hardware and software. The same applies to the V phase detector and the W phase detector.

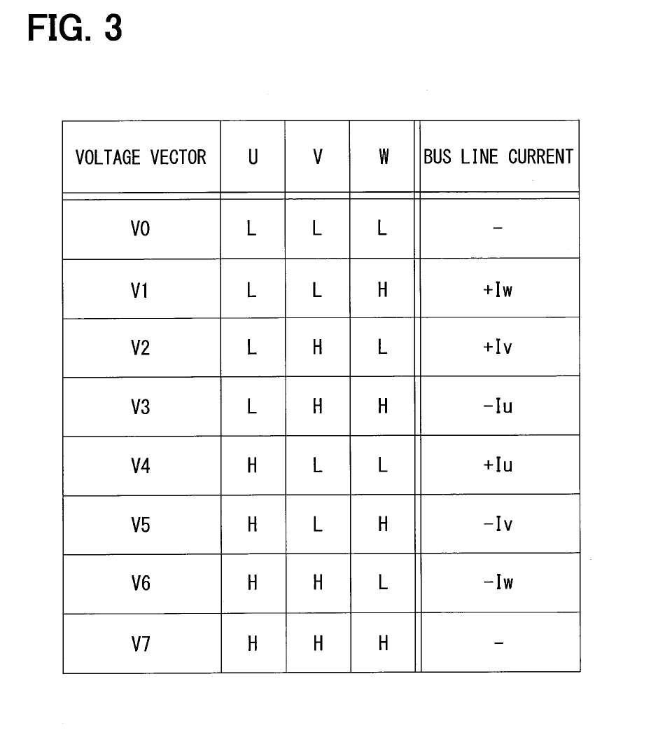

Here, the detection operation of the electric current in the present embodiment is described based on FIGS. 3-5.

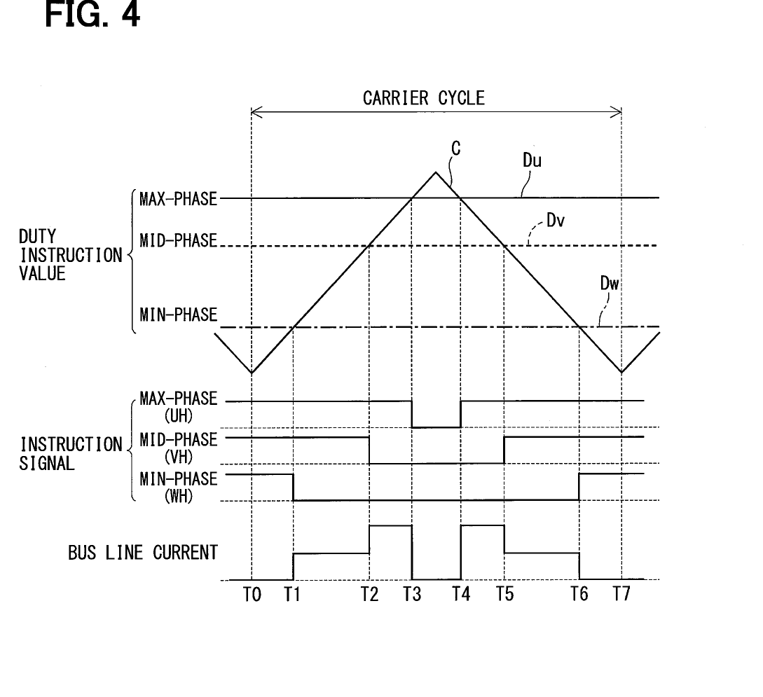

FIG. 3 shows the relationship between a combination of switching on-off of the SW 21-26 and the bus line current supplied to the shunt resistor 30. In FIG. 3, “H” represents (a combination of) an ON state of the upper arm elements 21-23 and an OFF state of the lower arm elements 24-26 in the U, V, W phases, and “L” represents (a combination of) an OFF state of the upper arm elements 21-23 and an OFF state of the lower arm elements 24-26 in those phases. Further, an electric current flowing from the inverter 20 to the winding wire 15 is represented by a “+” sign, and an electric current flowing from the winding wire 15 to the inverter 20 is represented by a “-” (i.e., minus) sign. Further, in FIG. 4, a maximum phase having the largest duty instruction value is the U phase, a middle phase having a middle duty instruction value is the V phase, and a minimum phase having the smallest duty instruction value is the W phase. Further, the instruction signals UL, VL, WL concerning the lower arm elements 24-26 are omitted.

As shown in FIG. 3, there are eight kinds of voltage vector patterns according to the combination of switching on-off of the SW 21-26. Among them, a V0 voltage vector whose lower arm elements 24-26 are ON altogether, and a V7 voltage vector whose upper arm elements 21-23 are ON altogether are respectively zero voltage vectors. When the voltage vector is a zero voltage vector, the bus line current which flows in the shunt resistor 30 is zero, thereby no electric current is detected.

A V1 voltage vector to a V6 voltage vector which respectively have at least one of the upper arm elements 21-23 switched ON and at least one of the lower arm elements 24-26 switched ON are active voltage vectors. When the voltage vector is an active voltage vector, the bus line current flowing in the shunt resistor 30 is equal to the electric current in a phase whose switched-on arm is different from the switched-on arms in other two phases.

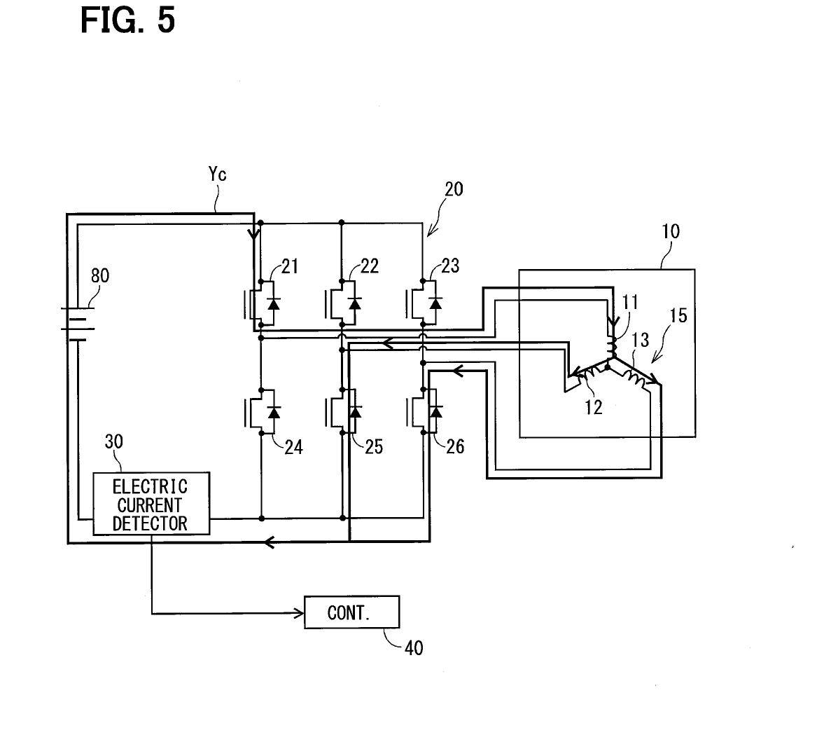

More practically, as for a period from time T2 to time T3 in FIG. 4, the U phase has the upper arm element 21 switched ON and the V and W phases have the lower arm elements 25, 26 switched ON, which creates the V4 voltage vector. During such period, the electric current flows along a path that is shown in FIG. 5 as an arrow Yc, the electric current flowing in the shunt resistor 30 is equal to the electric current (+Iu) which flows from the inverter 20 to the U phase coil 11.

Returning to FIG. 4, as for a period from time T5 to time T6, the upper arm elements 21 and 22 in the U and V phases are switched ON and the lower arm element 26 in the W phase is switched ON, which creates the V6 voltage vector. During such period, the electric current flowing in the shunt resistor 30 is equal to the electric current (−Iw) which flows from the W phase coil 13 to the inverter 20.

In the present embodiment, since the electric current is detected by using only one shunt resistor 30, the electric current is detected in two active voltage vector periods which can detect the electric current in (two) different phases. According to the present embodiment, in one cycle of the carrier signal C, the current detection is performed twice. In an example shown in FIG. 4, the detected electric current value Ic detected in a V4 voltage-vector period from time T2 to time T3 is considered as an electric current +Iu, and the detected electric current value Ic detected in a V6 voltage-vector period from time T5 to time T6 is considered as an electric current −Iw. Then, in the electric current calculator 41, each of the three phase currents Iu, Iv, Iw (i.e., a remaining one phase current, which is the V phase current Iv in the example of FIG. 4) is calculated based on a sum of three-phase currents=0 and the two other phase currents.

In the above, since a “ringing” which means a turbulence of the electric current flowing in the shunt resistor 30 is caused when the on-off state of the SW 21-26 switches, the electric current detection needs to be performed after such ringing is converged. Therefore, the electric current detection is performed within an active voltage vector period, and is performed at a ringing converged timing which is a timing measured from a start of the active voltage vector period at least after a lapse of a “ringing convergence time” that is required for the convergence of the ringing. For example, when the electric current detection is performed at a midpoint timing of an active voltage vector period, the active voltage vector period has to at least have a double length of the “ringing convergence time.” According to the present embodiment, the ringing convergence time corresponds to a “minimum retention time that is a time period between (i) a start of a voltage vector period for a detection of an electric current by the electric current detector and (ii) an electric current detection timing (i.e., an actual timing of electric current detection).”

Here, a case in which an open failure which disables conduction of the lower arm element 26 in the W phase is caused is described.

When the lower arm element 26 is normal, a period from time T2 to time T3 is the V4 voltage vector, as indicated by an arrow Yc in FIG. 5, and the electric current flows from the inverter 20 to the U phase coil 11, and the electric current also flows from the V phase coil 12 and the W phase coil 13 to the inverter 20. During such period, the electric current flowing in the shunt resistor 30 is equal to the electric current (+Iu) which flows from the inverter 20 to the U phase coil 11 as described above.

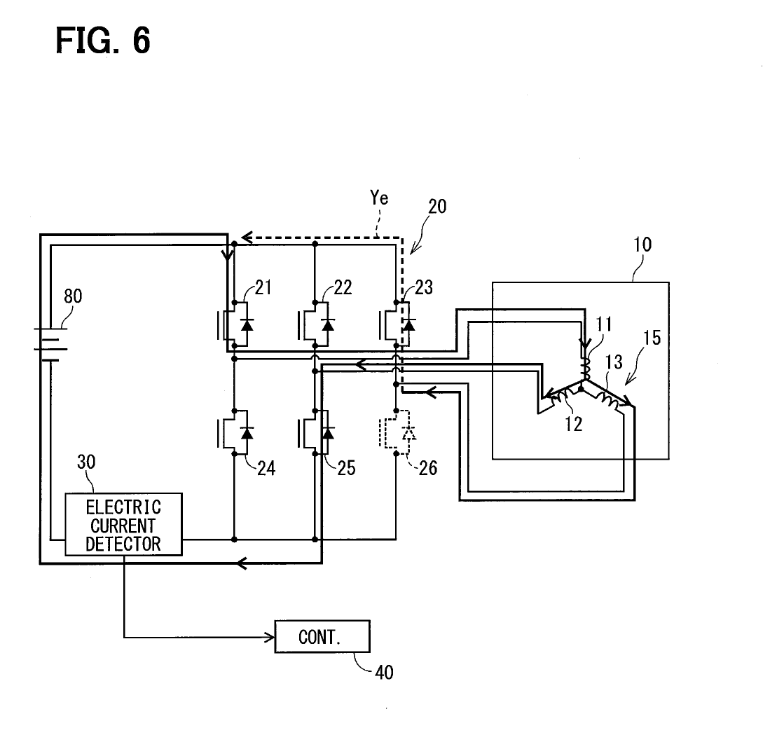

When an open failure is caused in the lower arm element 26, although the electric current supplied to the motor 10 will not change, a flow (Yc) of the electric current flowing from the W phase coil 13 to the inverter 20 during the period from time T2 to time T3 is changed to another flow as shown in FIG. 6 by an arrow Ye, which flows through a diode of the upper arm element 23 in the W phase to the upper arm element 21 in the U phase which is switched on. During such period, the electric current flowing in the shunt resistor 30 is equal to the current (−Iv) which flows from the V phase coil 12 to the inverter 20.

Since the controller 40 internally considers that the period from time T2 to time T3 is the V4 voltage vector period, when an open failure is caused in the lower arm element 26, the detected current value Ic is, even though it actually is equal to the electric current (−Iv) which flows from the V phase coil 12 to the inverter 20, mis-detected as being equal to the electric current (+Iu) which flows from the inverter 20 to the U phase coil 11.

That is, the controller 40 possibly mis-detects the flow direction and the phase of the bus line current that corresponds to the detected current value Ic, when an open failure is caused in the SW 21-26. Therefore, when an open failure is caused in the SW 21-26, if a drive of the motor 10 is based on each of the phase currents Iu, Iv, Iw that are derived from a mis-detected flow direction and phase of the detected electric current value Ic, such a drive of the motor 10 may lead to an unintended behavior of the motor 10 such as a reverse rotation or the like.

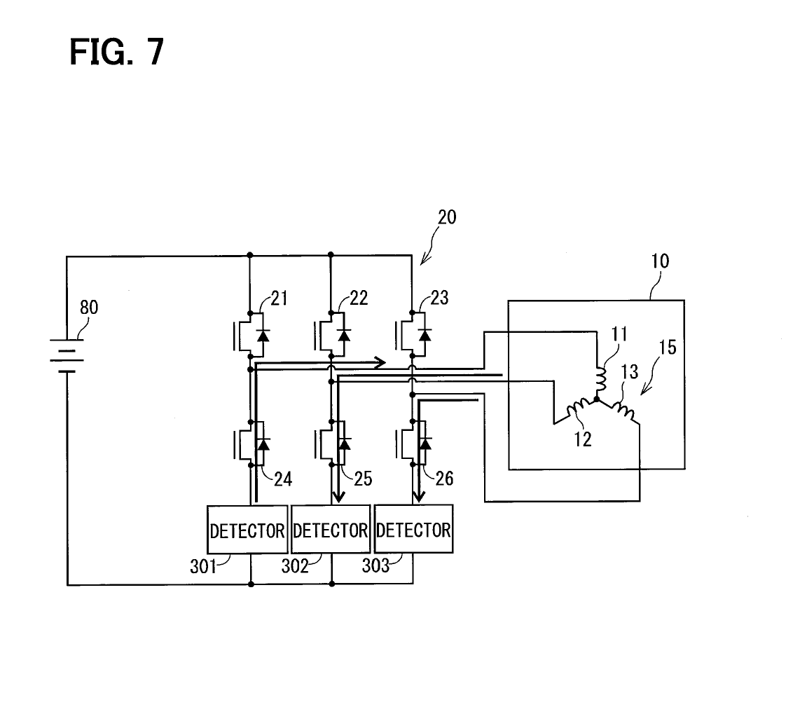

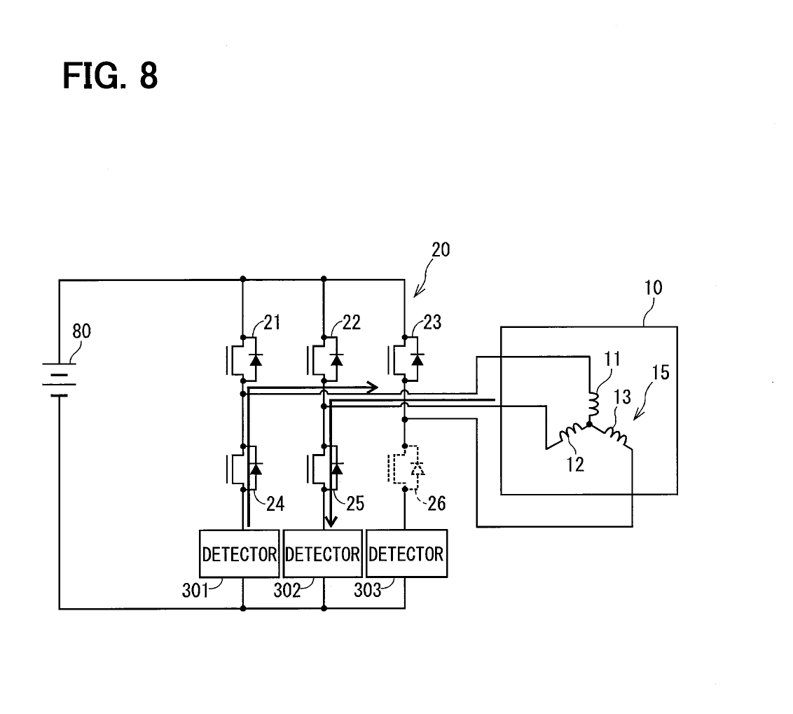

Further, as shown in FIG. 7, when electric current detectors 301, 302, 303 which are shunt resistors are disposed in each of those phases, each of the phase currents Iu, Iv, Iw is detected during the V0 voltage vector period in which all of the lower arm elements 24-26 are switched on. When all of the SW 21-26 are normal, the electric current according to the latest switch state is detected by the shunt resistors 301-303. Further, as shown in FIG. 8, when the lower arm element 26 has an open failure, even though the detected current value detected by the shunt resistor 303 sticks to/stays zero, the U phase current Iu detected by the shunt resistor 301 and the V phase current Iv detected by the shunt resistor 302 are normally/correctly detectable, which are not prone to mis-detection, in terms of the flow direction and the phase of the detected electric current.

In FIGS. 5-8, in order to provide ease of reading, components such as the position sensor 16, the custom IC 50 etc. as well as a part of the control lines are omitted from the drawing.

The “open failure” in a context of the present embodiment means that each of the SW 21-26 is not “conductive,” which not only includes a breakage of each of the SW 21-26 itself but also includes abnormalities of the instruction signals UH, UL, VH, VL, WH, WL outputted from the controller 40 and abnormalities of the amplified signals UHG, ULG, VHG, VLG, WHG, WLG outputted from the signal amplifier 51.

In the present embodiment, for the avoidance of the mis-detection of each of the phase currents Iu, Iv, Iw, the abnormality detector 55 monitors the abnormalities of the amplified signals UHG, ULG, VHG, VLG, WHG, WLG.

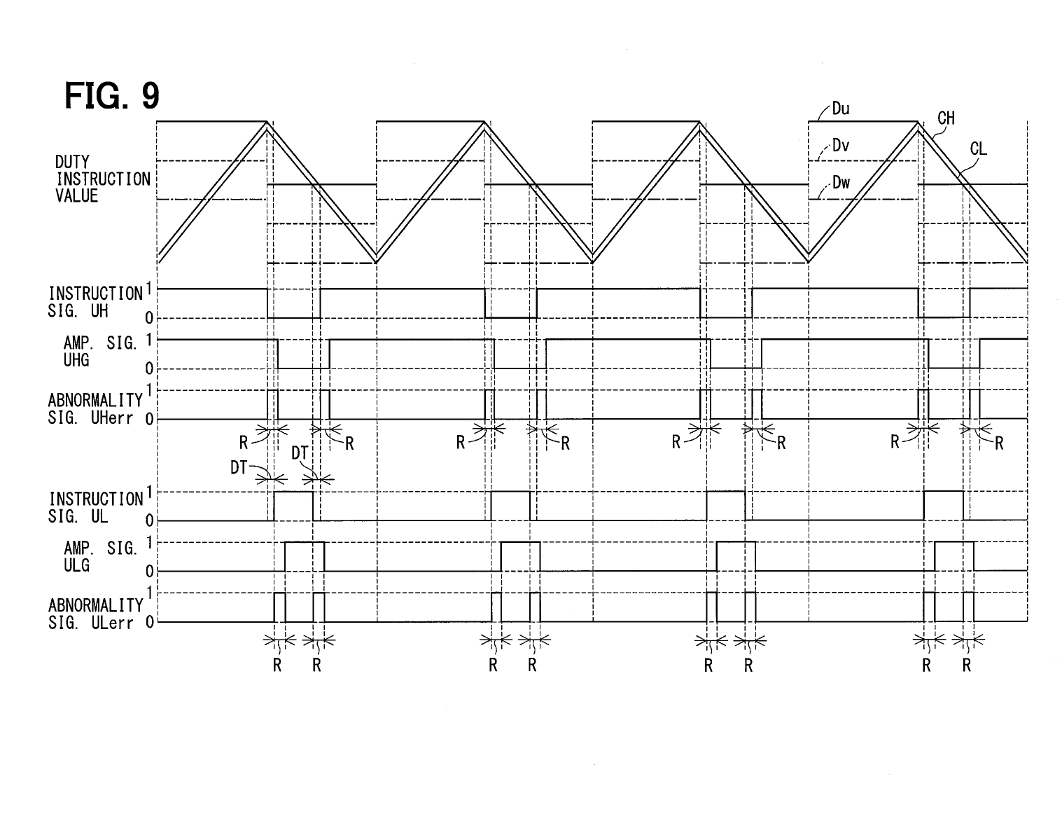

FIG. 9 shows an example of a normal case, in which the instruction signals UH, UL based on the duty instruction values Du, Dv, Dw and the carrier signal C are normal. In FIG. 9, a solid line represents the duty instruction value Du, a broken line represents the duty instruction value Dv, and a dot-dash line represents the duty instruction value Dw. Further, a dead time DT is shown only for one cycle of the carrier signal C, and omitted from the other cycles.

In the present embodiment, in one cycle of the carrier signal C (refer to FIG. 4), a former period is a portion from a valley to a peak and a latter period is a portion from the peak to the valley. In the former period, a neutral point voltage is changed so that the duty of the largest phase among the duty instruction values Du, Dv, Dw serves as a predetermined upper limit. In the latter period, the neutral point voltage is changed so that the duty of the smallest phase among the duty instruction values Du, Dv, Dw serves as a predetermined lower limit. In such case, even when the neutral point voltage is changed, the line voltage does not change.

The carrier signal C comprises an upper carrier signal CH concerning a control of the upper arm elements 21-23 and a lower carrier signal CL concerning a control of the lower arm elements 24-26. In the present embodiment, a short circuit by a simultaneous switch ON of (both of) the upper arm elements 21-23 and the lower arm element 24-26 in the same phase is prevented, by devising a shift between the upper carrier signal CH and the lower carrier signal CL, which creates the dead time during which a switching OFF of both of a pair of the upper and lower elements in the same phase is realized, i.e., for three pairs of the elements 21 and 24, 22 and 25, 23 and 26.

Moreover, at the peak of the carrier signal C, for a prevention of a simultaneous switch ON of the upper arm element 21 and the lower arm element 24 in the maximum phase (i.e., in the U phase in FIG. 9), the switch ON timing of the lower arm element 24 is delayed by an amount of the dead time DT. Similarly, at the bottom of the valley of the carrier signal C, for a prevention of a simultaneous switch ON of the upper arm element 23 and the lower arm element 26 in the minimum phase (i.e., in the W phase in FIG. 9), the switch ON timing of the upper arm element 23 is delayed by an amount of the dead time DT.

With reference to FIG. 9, the U phase is taken as an example of how abnormalities of the amplified signals UHG, ULG, VHG, VLG, WHG, WLG are detected.

When the duty instruction value Du is greater than the upper carrier signal CH, the instruction signal UH serves as an ON instruction, and when the duty instruction value Du is smaller than the upper carrier signal CH, the instruction signal UH serves as an OFF instruction.

Further, when the duty instruction value Du is smaller than lower the carrier signal CL, the instruction signal UL serves as an OFF instruction, and when the duty instruction value Du is greater than lower the carrier signal CL, the instruction signal UL serves as an ON instruction.

Thereby, other than the dead time DT, one of the instruction signals UH and UL serves as an ON instruction, and the other of the two instruction signals serves as an OFF instruction. Further, during the dead time DT, both of the instruction signals UH and UL serve as an OFF instruction.

When the signal amplifier 51 is normal, the amplified signal UHG behaves like the instruction signal UH with a response delay time R, and the amplified signal ULG behaves like the instruction signal UL with the response delay time R.

Thus, the abnormality detector 55 detects a state in which one of the instruction signal UH and the amplified signal UHG is an ON instruction and the other of the two is an OFF instruction.

When both of the instruction signal UH and the amplified signal UHG are ON instructions, or, when both of the two signals are OFF instructions, the amplified signal UHG is normal, thereby putting an abnormal signal UHerr in a low level (i.e., “0” level in the drawing).

When one of the instruction signal UH and the amplified signal UHG is an ON instruction and the other of the two signals is an OFF instruction, the abnormal signal UHerr is put in a high level (i.e., “1” level in the drawing). When the abnormal signal UHerr is in a high level, the count of an abnormal counter is started.

The same applies to a combination of the instruction signal UL and the amplified signal ULG. That is, when both of the instruction signal UL and the amplified signal ULG are ON instructions, or, when both are OFF instructions, an abnormal signal ULerr is put in a low level.

When one of the instruction signal UL and the amplified signal ULG is an ON instruction, and the other is an OFF instruction, the abnormal signal ULerr is put in a high level and the count of the abnormal counter is started.

In the following, the abnormality determination of the amplified signals UHG and ULG is performed in the same manner, the abnormality determination of the amplified signal UHG is described as an example.

As mentioned above, even when the amplified signal UHG is normal, during the response delay time R, the abnormal signal UHerr is temporarily put in a high level, and the count of the abnormal counter is started. After the lapse of the response delay time R, the abnormal signal UHerr returns to a low level, and the abnormal counter will be reset.

In FIG. 9, although the response delay time R is illustrated as taking a greater space than the dead time DT, the response delay time R and the dead time DT may arbitrarily be set according to circuit design requirements, etc.

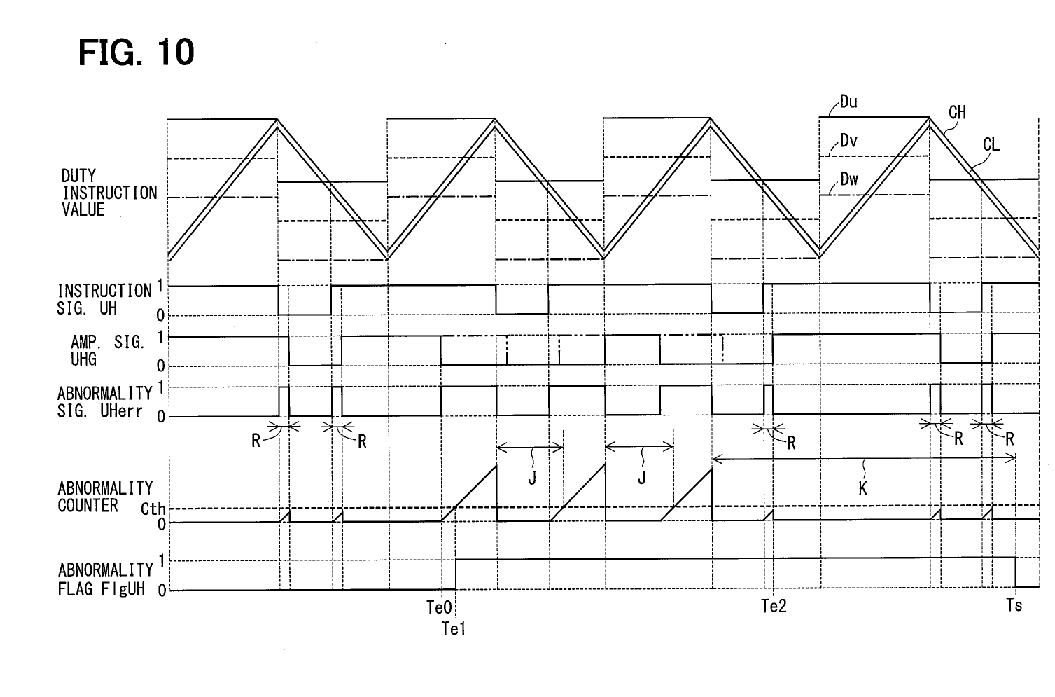

An amplified signal UHG abnormality case is described based on FIG. 10. The duty instruction values Du, Dv, Dw of FIG. 10 and the carrier signals CH and CL are the same as that of FIG. 9.

In FIG. 10, abnormalities arise in the amplified signal UHG at time Te0, and the amplified signal UHG returns to normal at time Te2. In FIG. 10, a two-dot chain line represents the amplified signal UHG of the normal time.

At time Te0, the amplified signal UHG switches from an ON instruction to an OFF instruction. Further, as for the instruction signal UH, it continues to be an ON instruction. In such case, since the instruction signal UH serves as an ON instruction and the amplified signal UHG serves as an OFF instruction, the abnormal signal UHerr is put in a high level. When the abnormal signal UHerr is put in a high level, the count of the abnormal counter is started.

When the counted value of the abnormal counter exceeds an abnormality determination threshold value Cth at time Tel, the U phase upper abnormality flag FlgUH is set. In the following, a set state of the U phase upper abnormality flag FlgUH is described as “1,” and a not-state of the flag FlgUH is described as “0.”

Here, the abnormality determination threshold value Cth is described.

In the present embodiment, when an abnormal state is detected in which one of the instruction signal UH and the amplified signal UHG is an ON instruction and the other of the two is an OFF instruction, the abnormal signal UHerr is put in a high level and the count of the abnormal counter is started. Further, the on-off switching of the amplified signal UHG is delayed by the response delay time R from the on-off switching of the instruction signal UH. Therefore, even when the amplified signal UHG is normal, the abnormal signal UHerr is put in a high level during the response delay time R, and the count of the abnormal counter is started.

Thus, according to the present embodiment, the abnormality determination threshold value Cth is set as a greater value than the value corresponding to the response delay time R, for the prevention of a fault determination in which a one-ON one-OFF state of the two signals UH and UHG are mis-determined as abnormal during the response delay time R.

Further, in the present embodiment, after an end of the ringing convergence time from the start of the active voltage vector period, the detection of the electric current is performed. In other words, the detection of the electric current is not performed within the ringing convergence time from the switching of on-off state of the SW 21-26. Thus, the abnormality determination threshold value Cth is set to be equal to or smaller than the value corresponding to the ringing convergence time. In such manner, a mis-detection of the phase and the flow direction of the detected current value Ic due to the abnormalities of the amplified signal UHG is prevented. In the present embodiment, the time corresponding to the abnormality determination threshold value Cth corresponds to an “abnormality determination time” in the claims.

In the present embodiment, at time Ts when a communication request from the controller section 40 is transmitted, the information regarding the abnormality flag is transmitted to the controller section 40. Therefore, when the U phase upper abnormality flag FlgUH is set, during a period (i) from the time Te1 when the U phase upper abnormality flag FlgUH is set (ii) to the time Ts when the information regarding the U phase upper abnormality flag FlgUH is transmitted, a flag set state is retained in which the U phase upper abnormality flag FlgUH is held in a set state.

That is, even when the amplified signal UHG is abnormal, both of the instruction signal UH and the amplified signal UHG may become an ON instruction or an OFF instruction, and the abnormal signal UHerr may be temporarily put in a low level. In such case, although the abnormal counter is once reset, the set state of the U phase upper abnormality flag FlgUH in which the flag FlgUH is kept in a set state is retained for a period J between (i) a reset of the abnormal counter and (ii) an excess of the counted value of the abnormal counter in excess of the abnormality determination threshold value Cth again.

Further, even in case that the amplified signal UHG returns to normal, the set state of the flag FlgUH is retained during a period K which is defined as a time period (from a temporary abnormality of the amplified signal UHG) until a timing when the U phase upper abnormality flag FlgUH is (actually) transmitted to the controller section 40, so that the temporary abnormality of the amplified signal UHG will not be missed by the controller section 40.

After the transmission of the information about the abnormality flag to the controller section 40 based on the request therefrom, the U phase upper abnormality flag FlgUH is reset.

If the information concerning the U phase upper abnormality flag FlgUH transmitted to the controller section 40 next is information which shows that the amplified signal UHG is normal, the abnormalities of the amplified signal UHG is determined as a temporary one by the controller section 40.

The abnormality detection of the instruction signals UH and UL is performed by a different process. Since the high-side instruction signal UH and the low-side instruction signal UL alternatively become ON and OFF instructions (i.e., one-ON one-OFF) other than the dead time DT, in case, for example, that both of the high-side instruction signal UH and the low-side instruction signal UL continue to be an ON instruction or an OFF instruction for a period that is longer than the instruction signal abnormality determination time, which is configured to be a time period of (i) greater than the dead time DT and (ii) equal to or shorter than the minimum retention time, the instruction signals UH and UL are determined as abnormal. The same applies to the combinations of the instruction signals VH and VL and the instruction signals WH and WL. In the present embodiment, an abnormality determination process of the amplified signals UHG, ULG, VHG, VLG, WHG, WLG is based on an assumption that the instruction signals UH, UL, VH, VL, WH, WL are normal.

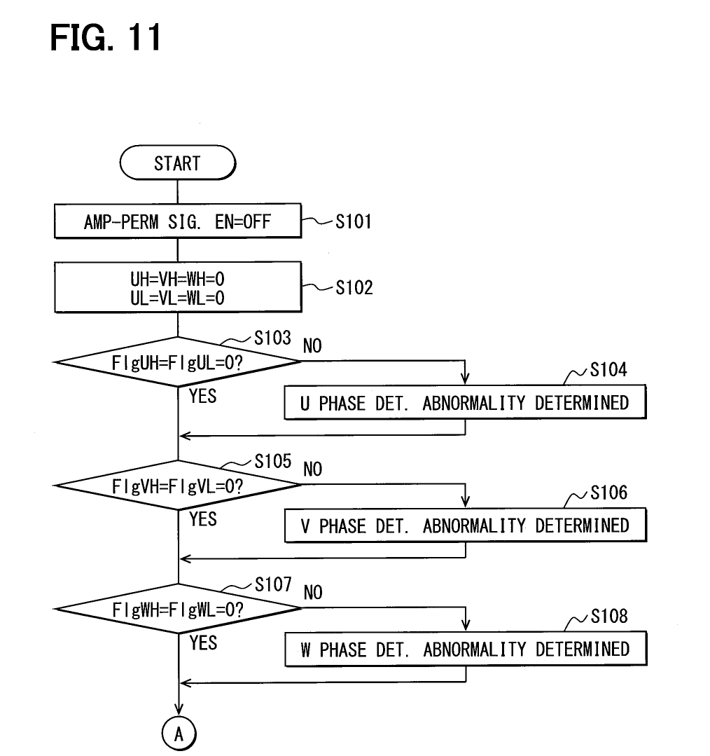

The abnormality determination process of the present embodiment is described based on FIGS. 11-14.

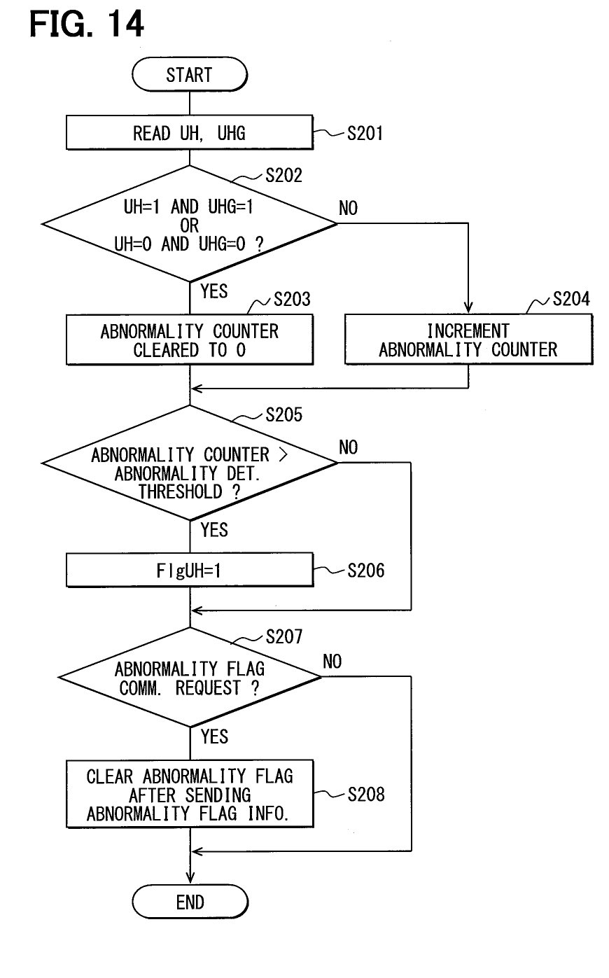

FIGS. 11-13 are flowcharts concerning an initial check process performed by the monitor section 43, which is performed before the abnormality determination process shown in FIG. 14.

As shown in FIG. 11, in step S101 (hereafter, a “step” abbreviated to a sign “S”), the amplification permission signal EN transmitted to the signal amplifier 51 from the controller section 40 is switched OFF.

In S102, all of the instruction signals UH, UL, VH, VL, WH, WL become an OFF instruction. At such moment, if the operation is normal, the amplified signals UHG, ULG, VHG, VLG, WHG, WLG all serve as an OFF instruction, and each of the abnormality flags FlgUH, FlgUL, FlgVH, FlgVL, FlgWH, FlgWL is set to 0.

In S103, it is determined whether the U phase upper abnormality flag FlgUH=0 and the U phase lower abnormality flag FlgUL=0. When it is determined that the U phase upper abnormality flag FlgUH=0 and the U phase lower abnormality flag FlgUL=0 (S103:YES), it is determined that there is no abnormality (i.e., it is determined that the U phase detector in the abnormality detector 55 has no abnormalities, or in other words, a normal operation of the U phase detector is determined) and the process shifts to S105. When it is determined that the U phase upper abnormality flag FlgUH=1 or the U phase lower abnormality flag FlgUL=1 (S103:NO), the process shifts to S104.

In S104, it is determined that the U phase detector in the abnormality detector 55 has abnormalities.

In S105, it is determined whether the V phase upper abnormality flag FlgVH=0 and the V phase lower abnormality flag FlgVL=0. When it is determined that the V phase upper abnormality flag FlgVH=0 and the V phase lower abnormality flag FlgVL=0 (S105:YES), it is determined that there is no abnormality (i.e., a normal operation of the V phase detector is determined) and the process shifts to S107. When it is determined that the V phase upper abnormality flag FlgVH=1 or the V phase lower abnormality flag FlgVL=1 (S105:NO), the process shifts to S106.

In S106, it is determined that the V phase detector in the abnormality detector 55 has abnormalities.

In S107, it is determined whether the W phase upper abnormality flag

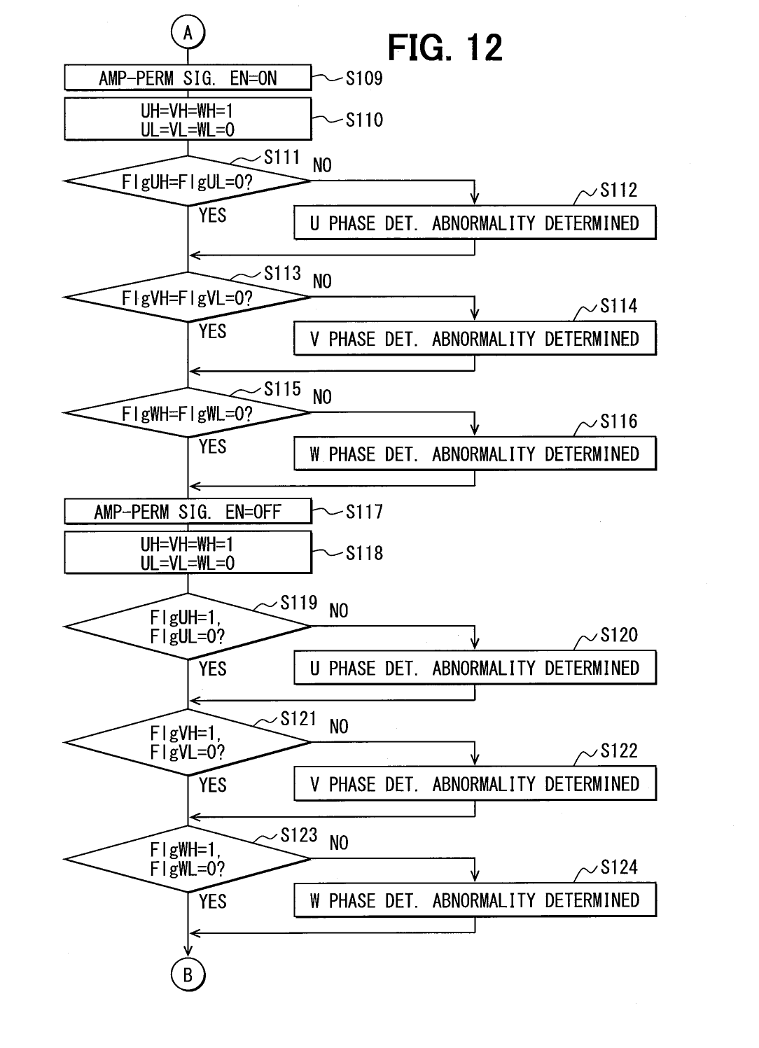

FlgWH=0 and the W phase lower abnormality flag FlgWL=0. When it is determined that the W phase upper abnormality flag FlgWH=0 and the W phase lower abnormality flag FlgWL=0 (S107:YES), it is determined that there is no abnormality (i.e., a normal operation of the W phase detector is determined) and the process shifts to S109 in FIG. 12. When it is determined that the W phase upper abnormality flag FlgWH=1 or the W phase lower abnormality flag FlgWL=1 (S107:NO), the process shifts to S108.

In S108, it is determined that the W phase detector in the abnormality detector 55 has abnormalities.

The amplification permission signal EN is switched ON in S109 of FIG. 12.

In S110, the high-side instruction signals UH, VH, WH concerning the drive of the upper arm elements 21-23 are set as ON instructions, and the low-side instruction signals UL, VL, WL concerning the drive of the lower arm elements 24-26 are set as OFF instructions. In such case, if the operation is normal, the amplified signals UHG, VHG, WHG corresponding to the high-side instruction signals UH, VH, WH serve as an ON instruction, and the amplified signals ULG, VLG, WLG corresponding to the low-side instruction signals UL, VL, WL serve as an OFF instruction. Further, if the operation is normal, each of the abnormality flags FlgUH, FlgUL, FlgVH, FlgVL, FlgWH, FlgWL is set to 0. Process in each of S111-S116 is the same as the process in each of S103-S116 in FIG. 11.

The amplification permission signal EN is switched OFF in S117. In S118, just like in S110, the high-side instruction signals UH, VH, WH concerning the drive of the upper arm elements 21-23 are set as ON instructions, and the low-side instruction signals UL, VL, WL are set as OFF instructions. In such case, since the amplification permission signal EN is switched off, if the operation is, the amplified signals UHG, ULG, VHG, VLG, WHG, WLG serve as an OFF instruction. Further, if the operation is normal, the abnormality flags FlgUH, FlgVH, FlgWH are set to “1,” and the abnormality flags FlgUL, FlgVL, FlgWL are set to “0.”

In S119, it is determined whether the U phase upper abnormality flag FlgUH=1 and the U phase lower abnormality flag FlgUL=0. When it is determined that the U phase upper abnormality flag FlgUH=1 and the U phase lower abnormality flag FlgUL=0 (S119:YES), it is determined that there is no abnormality (i.e., a normal operation of the U phase detector is determined) and the process shifts to S121. When it is determined that the U phase upper abnormality flag FlgUH=0 or the U phase lower abnormality flag FlgUL=1 (S119:NO), the process shifts to S120.

In S120, it is determined that the U phase detector in the abnormality detector 55 has abnormalities.

In S121, it is determined whether the V phase upper abnormality flag FlgVH=1 and the V phase lower abnormality flag FlgVL=0. When it is determined that the V phase upper abnormality flag FlgVH=1 and the V phase lower abnormality flag FlgVL=0 (S121:YES), it is determined that there is no abnormality (i.e., a normal operation of the V phase detector is determined) and the process shifts to S123. When it is determined that the V phase upper abnormality flag FlgVH=0 or the V phase lower abnormality flag FlgVL=1 (S121:NO), the process shifts to S122.

In S122, it is determined that the V phase detector in the abnormality detector 55 has abnormalities.

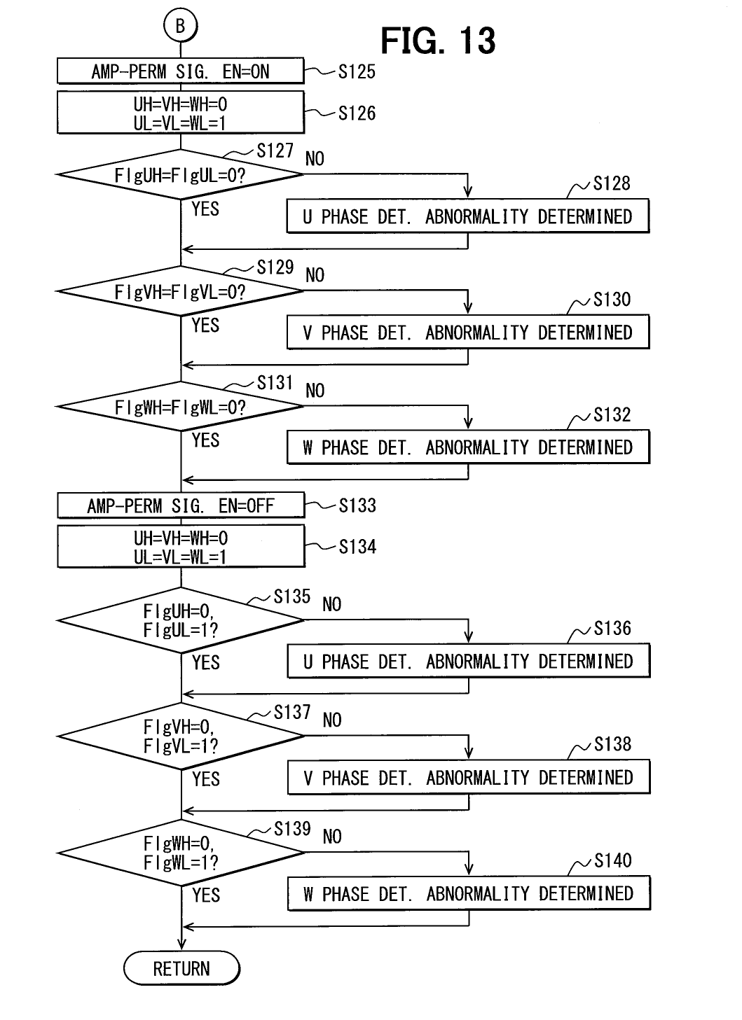

In S123, it is determined whether the W phase upper abnormality flag FlgWH=1 and the W phase lower abnormality flag FlgWL=0. When it is determined that the W phase upper abnormality flag FlgWH=1 and the W phase lower abnormality flag FlgWL=0 (S123:YES), it is determined that there is no abnormality (i.e., a normal operation of the W phase detector is determined) and the process shifts to S125 in FIG. 13. When it is determined the W phase upper abnormality flag FlgWH=0 or the W phase lower abnormality flag FlgWL=1 (S123:NO), the process shifts to S124.

In S124, it is determined that the W phase detector in the abnormality detector 55 has abnormalities.

The amplification permission signal EN is switched ON in S125 in FIG. 13.

In S126, the high-side instruction signals UH, VH, WH are set to OFF instructions, and the low-side instruction signals UL, V L, WL are set to ON instructions. In such case, if the operation is normal, the amplified signals UHG, VHG, WHG corresponding to the high-side instruction signals UH, VH, WH serve as an OFF instruction, and the amplified signals ULG, VLG, WLG corresponding to the low-side instruction signals UL, VL, WL serve as an ON instruction. In such case, if the operation is normal, each of the abnormality flags FlgUH, FlgUL, FlgVH, FlgVL, FlgWH, FlgWL is set to “0.”

The process concerning each of S127-S132 is the same as that of S103-S106 in FIG. 11.

The amplification permission signal EN is switched OFF in S133. In S134, just like S126, the high-side instruction signals UH, VH, WH are set to OFF instructions, and the low-side instruction signals UL, VL, WL are set to ON instructions. Here, since the amplification permission signal EN is switched off, if the operation is normal, the amplified signals UHG, ULG, VHG, VLG, WHG, WLG serve as an OFF instruction. Further, if the operation is normal, the abnormality flags FlgUH, FlgVH, FlgWH are also set to “0,” and the abnormality flags FlgUL, FlgVL, FlgWL are also set to “1.”

In S135, it is determined whether the U phase upper abnormality flag FlgUH=0 and the U phase lower abnormality flag FlgUL=1. When it is determined that the U phase upper abnormality flag FlgUH=0 and the U phase lower abnormality flag FlgUL=1 (S135:YES), it is determined that there is no abnormality (i.e., a normal operation of the U phase detector is determined) and the process shifts to S137. When it is determined that the U phase upper abnormality flag FlgUH=1 or the U phase lower abnormality flag FlgUL=0 (S135:NO), the process shifts to S136.

In S136, it is determined that the U phase detector in the abnormality detector 55 has abnormalities.

In S137, it is determined whether the V phase upper abnormality flag FlgVH=0 and the V phase lower abnormality flag FlgVL=1. When it is determined that the V phase upper abnormality flag FlgVH=0 and the V phase lower abnormality flag FlgVL=1 (S137:YES), it is determined that there is no abnormality (i.e., a normal operation of the V phase detector is determined) and the process shifts to S139. When it is determined that the V phase upper abnormality flag FlgVH=1 or the V phase lower abnormality flag FlgVL=0 (S137:NO), the process shifts to S138.

In S138, it is determined that the V phase detector of the abnormality detector 55 has abnormalities.

In S139, it is determined whether the W phase upper abnormality flag FlgWH=0 and the W phase lower abnormality flag FlgWL=1. When it is determined that the W phase upper abnormality flag FlgWH=0 and the W phase lower abnormality flag FlgWL=1 (S139:YES), it is determined that there is no abnormality (i.e., a normal operation of the W phase detector is determined), and the initial check process is ended. When it is determined that the W phase upper abnormality flag FlgWH=1 or the W phase lower abnormality flag FlgWL=0 (S139:NO), the process shifts to S140.

In S140, it is determined that the W phase detector in the abnormality detector 55 has abnormalities, and the initial check process is ended.

Thereby, it is determined that the abnormality detection function in the abnormality detector 55 is normal. Here, “the abnormality detection function in the abnormality detector 55 is normal” means that there is no break/disconnection and/or no short circuit to a high-/low-side in a path from the terminals P11-P16 to the abnormality detector 55 and in a path from the terminals P21-P26 to the abnormality detector 55.

The abnormality determination process performed after the initial check process is described based on FIG. 14. The abnormality determination process shown in FIG. 14 is performed after the initial check process and when the rotating electric machine driver 1 is switched on in the abnormality detector 55 at predetermined intervals. Here, in the present embodiment, the U phase detector performing a process regarding the abnormality determination of the amplified signal UHG is described, which should be substantially the same for the amplified signal ULG, and for the VM/phase detectors.

In S201, the process reads the instruction signal UH and the amplified signal UHG.

In both S202, the process determines whether the instruction signal UH and the amplified signal UHG are both ON instructions or both OFF instructions. Namely, when UH=UHG=0 or UH=UHG=1, the process yields an affirmative determination, and, when (i) UH=1 and UHG=0 or (ii) UH=0 and UHG=1, the process yields a negative determination.

When the process determines both of the instruction signal UH and the amplified signal UHG are ON instructions or when it is determined that both are OFF instructions (S202:YES), the process shift to S203. When the process determines that one of the instruction signal UH and the amplified signal UHG is an ON instruction, and the other of the two is an OFF instruction (S202:NO), the process shifts to S204.

In S203, the process clears the abnormal counter to “0.”

In S204, the process increments the abnormal counter.

In S205, the process determines whether the counted value of the abnormal counter is greater than the abnormality determination threshold value Cth.

When the counted value of the abnormal counter is determined to be equal to or smaller than the abnormality determination threshold value Cth (S205:NO), the process shifts to S207. When the process determines that the counted value of the abnormal counter is greater than the abnormality determination threshold value Cth (S205:YES), the process shifts to S206.

In S206, the process sets the U phase upper abnormality flag FlgUH.

In S207, the process determines whether the controller section 40 has issued a flag communication request. When the process determines that there is no flag communication request (S207:NO), the process of S208 is not performed. When the process determines that a flag communication request has been issued (S207:YES), the process shifts to S208.

In S208, the information about the U phase upper abnormality flag FlgUH is transmitted to the controller section 40, and the U phase upper abnormality flag FlgUH is reset/cleared after such transmission.

Process of FIGS. 11-14 may be performed/implemented by/as software, or may be performed/implemented by/as hardware. For example, when performing the process in FIG. 14 by hardware, a HI/LO determination circuit corresponding to S202, a counter circuit corresponding to S203 and S204, and a comparison circuit corresponding to S205 may only be employed to realize the required abnormality detection function for detecting the abnormalities of the amplified signal UHG with a simple circuit structure.

As described in full details above, the rotating electric machine driver 1 in the present embodiment is provided with the inverter 20, the shunt resistor 30, the controller section 40, the custom IC 50, and the abnormality detector 55.

The inverter 20 has the switching elements 21-26 provided in correspondence to each of the plural phases of the winding wire 15 of the motor 10.

The shunt resistor 30 detects the current supplied to the winding wire 15. The controller section 40 obtains the detected current value Ic detected by the shunt resistor 30, and generates the instruction signals UH, UL, VH, VL, WH, WL which switches on and off of the switching elements 21-26 based on detected current value Ic.

The custom IC 50 has the signal amplifier 51 which outputs the amplified signals UHG, ULG, VHG, VLG, WHG, WLG which are amplified instruction signals UH, UL, VH, VL, WH, WL outputted from the controller section 40 to the inverter 20.

The abnormality detector 55 determines the abnormality of the amplified signal UHG (S206), when an abnormal state continues at least for the abnormality determination time, in which one of the instruction signal UH and the amplified signal UHG which is the amplified instruction signal UH is an ON instruction and the other one of the two signals is an OFF instruction (S205:YES in FIG. 14).

Similarly, the abnormality detector 55 determines the abnormality of the amplified signal ULG, when the one-ON one-OFF state described above continues at least for the abnormality determination time regarding the instruction signal UL and the amplified signal ULG. The same abnormality determination scheme applies to the abnormality of the amplified signal VHG/VLG/WHG/WLG regarding the instruction signal VHNL/WH/WL and the amplified signal VHG/VLG/WHG/WLG.

Thereby, the abnormalities of the amplified signals UHG, ULG, VHG, VLG, WHG, WLG are appropriately detectable.

In the present embodiment, the shunt resistor 30 is disposed at a position between the inverter 20 and the negative side of the battery 80, and detects the bus line current. The controller section 40 calculates each of the phase currents Iu, Iv, Iw according to the on-off state of SW 21-26 based on the bus line current detected by the shunt resistor 30.

Therefore, when the open failure which cannot switch on the SW 21-26 at an expected switch-on timing is caused, the power supply direction and the phase of the electric current that is detected by the shunt resistor 30 as the detected current value Ic may possibly be mis-detected.

Therefore, in the present embodiment, the abnormalities of the amplified signals UHG, ULG, VHG, VLG, WHG, WLG are detected by the abnormality detector 55. By such detection of the abnormalities of the amplified signals, the open failure which is caused by the abnormalities of the amplified signals UHG, ULG, VHG, VLG, WHG, WLG becomes detectable, thereby preventing the mis-detection of each of the phase currents Iu, Iv, Iw and preventing the unintended behavior of the motor 10.

The abnormality determination time is configured to be longer than the response delay time R, which is a time period (i) from an output of the instruction signals UH, UL, VH, VL, WH, WL from the controller section 40 (ii) to an output of the amplified signals UHG, ULG, VHG, VLG, WHG, WLG from the signal amplifier 51 and is configured to be equal to or shorter than the minimum retention time which is a time period (i) from the start of the voltage vector period which an electric current detection time by the shunt resistor 30 (ii) to an actual detection of the electric current.

Thereby, a mis-detection that mis-detects the delay of the response as the abnormality is prevented. Further, the detected current value Ic is detected after the convergence of the ringing of the electric current supplied to the shunt resistor 30. Therefore, the minimum retention time may be set as the ringing convergence time that is set according to the time required for the convergence of the ringing, for example. When the abnormality determination time is set to be equal to or shorter than the minimum retention time, the detection of detected current value Ic will not be performed in a period between an abnormality caused time of the amplified signals UHG, ULG, VHG, VLG, WHG, WLG and an abnormality determination time, thereby securely preventing the mis-detection of each of the phase currents Iu, Iv, Iw.

The instruction signals comprises the high-side instruction signals UH, VH, WH that switch on and off the upper arm elements 21, 22, 23 which are the switching elements provided on the high potential side, and the low-side instruction signals UL, VL, WL which switch on and off the lower arm elements 24, 25, 26 provided on the low potential side of the upper arm elements 21, 22, 23.

The custom IC 50 has a self-protecting circuit 52 that comprises the U phase protection circuit, the V phase protection circuit, and the W phase protection circuit. The U phase protection circuit stops the generation of the amplified signals UHG, ULG when both of the high-side instruction signal UH and the low-side instruction signal UL for a pair of the upper arm element 21 and the lower arm element 24 which are paired are ON instructions. The V phase protection circuit stops the generation of the amplified signals VHG, VLG when both of the high-side instruction signal VH and the low-side instruction signal VL for a pair of the upper arm element 21 and the lower arm element 25 which are paired are ON instructions. The W phase protection circuit stops the generation of the amplified signals WHG, WLG when both of the high-side instruction signal WH and the low-side instruction signals WL for a pair of the upper arm element 23 and the lower arm element 26 which are paired are ON instructions.

Since, in the above-described manner, the upper arm elements 21-23 and the lower arm elements 24-26 which are paired are not simultaneously switched on even when the instruction signals UH, UL, VH, VL, WH, WL are abnormal, an excessive electric current is prevented.

In the present embodiment, the abnormality detector 55 is disposed in the custom IC 50. That is, the signal amplifier 51 and the abnormality detector 55 are provided in one custom IC 50. Thereby, the number of parts is reduced.

The controller section 40 has the monitor section 43 which determines whether the abnormality detection by the abnormality detector 55 is normally functioning or not. Thereby, the mis-detection of the abnormality of the amplified signals UHG, ULG, VHG, VLG, WHG, WLG, which is actually an abnormality of the abnormality detector 55, is prevented.

The electric power steering device 100 of the present embodiment is provided with the above-mentioned rotating electric machine driver 1 and the motor 10 which outputs the assist torque which assists the steering operation by the driver. In the rotating electric machine driver 1, the mis-detection of each of the phase currents Iu, Iv, Iw due to the abnormalities of the amplified signals UHG, ULG, VHG, VLG, WHG, WLG is prevented, which prevents the unintended behavior of the motor 10 and diminishes a wrong operation feeling of the driver by an “unintended” output of the assist torque from the motor 10.

### Other Embodiments

(a) Initial Check Process

In S101-S108 of the initial check process of the above-mentioned embodiment in FIG. 11, it confirms that, based on the amplification permission signal EN=OFF, the high-side instruction signals UH, VH, WH=ON, and the low-side instruction signals UL, VL, WL=OFF, the normal operation of the each of the U/V/W phase detectors is determined.

Further, in S109-S116 of the initial check process of the above-mentioned embodiment in FIG. 12, it confirms that, based on the amplification permission signal EN=ON, the high-side instruction signals UH, VH, WH=ON, and the low-side instruction signals UL, VL, WL=OFF, the normal operation of the each of the UN/W phase detectors is determined. Also, in S117-S124 of the initial check process of the above-mentioned embodiment in FIG. 12, it confirms that, based on the amplification permission signal EN=OFF, the high-side instruction signals UH, VH, WH=ON, and the low-side instruction signals UL, VL, WL=OFF, the abnormality determination of each of the amplification signals UHG/VHG/WHG is performed.

Further, in S125-S132 of the initial check process of the above-mentioned embodiment in FIG. 13, it confirms that, based on the amplification permission signal EN=ON, the high-side instruction signals UH, VH, WH=OFF, and the low-side instruction signals UL, VL, WL=ON, the normal operation of the each of the UN/W phase detectors is determined.

Also, in S133-S140 of the initial check process of the above-mentioned embodiment in FIG. 13, it confirms that, based on the amplification permission signal EN=OFF, the high-side instruction signals UH, VH, WH=OFF, and the low-side instruction signals UL, VL, WL=ON, the abnormality determination of each of the amplification signals UHG/VHG/WHG is performed.

For example, when a time period usable of the initial check is short, a part of S101-S108, S109-S116, S117-S124, S125-S132, or S133-S140 may be omitted. Further, when the abnormalities of one or more of the U/V/W phase detectors are determined, the process regarding the abnormality-determined W phase may be omitted thereafter.

Further, in S110 and S118, the high-side instruction signals UH, VH, WH are simultaneously switched to an ON instruction. In other embodiments, the high-side instruction signal UH may be switched to an ON instruction for performing the process of S111 and S112, the high-side instruction signal VH may be switched to an ON instruction for performing the process of S113 and S114, and the high-side instruction signal WH may be switched to an ON instruction for performing the process of S115 and S116, that is, the high-side instruction signals UH, VH, WH may be separately switched to an ON instruction signal. The same applies to the low-side instruction signals UL, VL, WL.

Further, at a timing between the S116 and S117, a process that switches all of the high-side instruction signals UH, VH, WH and the low-side instruction signals UL, VL, WL to an OFF instruction may be performed. In such manner, an abnormality of no-switching of the high-side instruction signals UH, VH, WH to an ON instruction after switching them to an OFF instruction is detectable.

Similarly, at a timing between the S132 and S133, a process that switches all of the high-side instruction signals UH, VH, WH and the low-side instruction signals UL, VL, WL to an OFF instruction may be performed. In such manner, an abnormality of no-switching of the low-side instruction signals UL, VL, WL to an OFF instruction after switching them to an ON instruction is detectable.

(b) Abnormality Determination Time

In the above-mentioned embodiment, abnormality determination time is set to be equal to or shorter than the ringing convergence time.

In other embodiments, the abnormality determination time may be configured to be equal to or shorter than the minimum retention time that is defined as a time period between (i) a start of a voltage vector period for a detection of an electric current by the electric current detector and (ii) an electric current detection timing (i.e., an actual timing of electric current detection)”, instead of being shorter than the ringing convergence time.

(c) Electric Current Detector

In the above-mentioned embodiment, the detected current value is detected in one cycle of a carrier signal during the active voltage vector period which can detect the electric current in different phases. That is, the detected current value is detected twice in one cycle of a carrier signal.

In other embodiments, the detected current value may be detected in one cycle of the electric current calculation by the electric current detector, according to the active voltage vector which can detect the electric current in different phases. For example, when the calculation of the electric current in each phase is performed during a two cycles period of the carrier signal, the electric current detection may be configured to be performed once in one cycle period of the carrier signal. Further, for example, when the calculation of the electric current in each phase is performed during a four cycles period of the carrier signal, the electric current detection may be configured to be performed once in a two cycles period of the carrier signal.

In the above-mentioned embodiment, the electric current detector is disposed at a position between the inverter section and the negative side of the power supply. In other embodiments, the electric current detector may be disposed at a position between the inverter section and the positive side of the power supply.

Further, for example, as shown in FIG. 7, the electric current detector may be provided for each of all phases. Even when the electric current detector is provided for each of all phases, the abnormalities of the amplified signal are appropriately detectable.

(d) Instruction Signal Generator

In the above-mentioned embodiment, the neutral point voltage is different for the former period and the latter period in one cycle of the carrier signal. In other embodiments, the neutral point voltage needs not necessarily be changed in one cycle of the carrier signal. Further, according to the electric current detection cycle, the neutral point voltage may be changed for every cycle.

Further, for securely reserving the minimum retention time that is required for performing the electric current detection, an appropriate correction process or the like may be performed.

Furthermore, in the above-mentioned embodiment, the carrier signal is a chopping wave signal. In other embodiments, the carrier signal may have any shape, e.g. a saw tooth wave signal or the like.

(e) Abnormality Detector

In the above-mentioned embodiment, the abnormality detector is disposed in the same driver circuit as the signal amplifier. In other embodiments, the abnormality detector may be disposed in a different circuit that is different from the signal amplifier. Further, in terms of establishing a functional safety, the abnormality detector is preferably provided as a different circuit that is different from the controller section.

(f) Rotating Electric Machine Driver

In the above-mentioned embodiment, the rotating electric machine driver is applied to an electric power steering device. In other embodiments, the rotating electric machine driver may be applied to a device other than the electric power steering device.

Although the present disclosure has been fully described in connection with preferred embodiment thereof with reference to the accompanying drawings, it is to be noted that various changes and modifications will become apparent to those skilled in the art, and such changes, modifications, and summarized scheme are to be understood as being within the scope of the present disclosure as defined by appended claims.

What is claimed is:

1. A rotating electric machine driving apparatus comprising:
an inverter section having a plurality of switching elements respectively corresponding to each of plural phases of a winding wire of a rotating electric machine;
an electric current detector detecting an electric current supplied to the winding wire;
a controller section obtaining a current detection value detected by the electric current detector and generating an instruction signal that switches an ON-OFF of the switching elements based on the current detection value;
a driver circuit having a signal amplifier that outputs an amplified signal to the inverter section, the amplified signal being derived from amplification of the instruction signal that is output from the controller section; and
an abnormality detector determining an abnormality of the amplified signal when a one-on one-off state continues for at least an abnormality determination time, the one-on one-off state being a state in which one of the instruction signal and the amplified signal is an ON instruction and an other of the instruction signal and the amplified signal is an OFF instruction.

2. The rotating electric machine driving apparatus of claim 1, wherein
a response delay time is defined as a time period between an output of the instruction signal from the controller section and an output of the amplified signal from the signal amplifier,
a minimum retention time is defined as a time period between a start timing of a voltage vector period during which an electric current is detected by the electric current detector and a detection timing for detecting the electric current, and
the abnormality determination time is longer than the response delay time and equal to or shorter than the minimum retention time.

3. The rotating electric machine driving apparatus of claim 1, further comprising:
a protection section in the driver circuit that stops a generation of the amplified signal, wherein
the instruction signal is a high-side instruction signal or a low-side instruction signal, the high-side instruction signal switching ON and OFF of an upper arm element disposed on a high potential side, and the low side instruction signal switching ON and OFF of a lower arm element disposed on a low voltage side with regard to the upper arm element on the high potential side, and
the protection section stops the generation of the amplified signal when both of the high-side instruction signal and the low-side instruction signal indicate switching ON of a pair of the upper arm element and the lower arm element.

4. The rotating electric machine driving apparatus of claim 1, wherein
the abnormality detector is disposed in the driver circuit.

5. The rotating electric machine driving apparatus of claim 1, wherein
the electric current detector is disposed at a position between (i) the inverter section and (ii) a positive side or a negative side of a power supply.

6. The rotating electric machine driving apparatus of claim 1, wherein
the controller section includes a monitor section that determines whether an abnormality detection by the abnormality detector is functioning normally.

7. An electric power steering apparatus comprising:
a rotating electric machine driving apparatus that outputs an assist torque for assisting a steering operation performed by a driver, the rotating electric machine driving apparatus includes
an inverter section having a plurality of switching elements respectively corresponding to each of plural phases of a winding wire of a rotating electric machine,
an electric current detector detecting an electric current supplied to the winding wire,
a controller section (i) obtaining a current detection value detected by the electric current detector, and (ii) generating an instruction signal that switches an ON-OFF of the switching elements based on the current detection value,
a driver circuit having a signal amplifier that outputs an amplified signal to the inverter section, the amplified signal being derived from amplification of the instruction signal that is output from the controller section, and
an abnormality detector determining an abnormality of the amplified signal when a one-on one-off state continues for at least an abnormality determination time, the one-on one-off state being a state in which one of the instruction signal and the amplified signal is an ON instruction and an other of the instruction signal and the amplified signal is an OFF instruction.
